(19) United States
(12) Patent Application Publication
(10) Pub. No.: US 2026/0042308 A1
(43) Pub. Date: Feb. 12, 2026

(54) PRINTER

(71) Applicant: TOSHIBA TEC KABUSHIKI KAISHA, Tokyo (JP)

(72) Inventors: Mitsuhiro Nozaki, Mishima Shizuoka (JP); Takahide Takahashi, Tagata Shizuoka (JP)

(21) Appl. No.: 19/186,709

(22) Filed: Apr. 23, 2025

(30) Foreign Application Priority Data
Aug. 8, 2024 (JP) 2024-132101

(51) Int. Cl. B41J 29/38; B41J 11/70

(52) U.S. Cl. CPC B41J 29/38; B41J 11/703

(57) ABSTRACT

According to one embodiment, a printer includes a first motor, a printing unit, a second motor, a charging circuit, and a connection unit. The first motor feeds a sheet. The printing unit forms an image on the sheet. When a rotational force is applied, the second motor converts the applied rotational force into electric power, and when electric power is applied, the second motor converts the applied electric power into a rotational force. The charging circuit holds the electric power converted from a rotational force of the first motor by the second motor, and supplies the held electric power when the printing unit forms an image. The connection unit receives electric power supplied via USB power delivery.

### CROSS-REFERENCE TO RELATED APPLICATION

This application is based upon and claims the benefit of priority from Japanese Patent Application No. 2024-132101, filed on Aug. 8, 2024, the entire contents of which are incorporated herein by reference.

### FIELD

Embodiments described herein relate generally to a printer, a thermal printer, and methods related thereto.

### BACKGROUND

There is an image forming device capable of regenerating energy.

### DESCRIPTION OF THE DRAWINGS

FIG. 1 is a block diagram illustrating a configuration example of a printer according to an embodiment.

FIG. 2 is a table illustrating a state of a switching unit.

FIG. 3 is a schematic view illustrating an arrangement of units.

FIG. 4 is a flowchart illustrating a printing operation of the printer.

FIG. 5 is a table illustrating an operation of a charging circuit.

### DETAILED DESCRIPTION

A printer that reduces a maximum value of electric power required for an external power source device is provided.

In general, according to one embodiment, the printer includes a first motor, a printing unit, a second motor, a charging circuit, and a connection unit. The first motor feeds a sheet. The printing unit forms an image on the sheet. When a rotational force is applied, the second motor converts the applied rotational force into electric power, and when electric power is applied, the second motor converts the applied electric power into a rotational force. The charging circuit holds the electric power converted from a rotational force of the first motor by the second motor, and supplies the held electric power when the printing unit forms an image. The connection unit receives electric power supplied via USB power delivery. According to another embodiment, a method for a printer involves feeding a printing sheet by a first motor; forming an image on the printing sheet; when a first rotational force of the first motor is applied to a second motor, converting the applied rotational force into electric power; when electric power of a power source circuit is applied to the second motor, converting the electric power of the power source circuit into a second rotational force; holding the electric power converted by the second motor from the first rotational force of the first motor in a charging circuit; supplying the held electric power when forming the image; and receiving electric power supplied through a connection component via USB power delivery.

Hereinafter, an embodiment will be described with reference to the drawings. In the description, components having substantially the same function and configuration are denoted by the same reference numerals. The following embodiment illustrates technical ideas. The embodiment does not specify a material, a shape, a structure, an arrangement, or the like of the components. The embodiment can be modified in various ways.

### Configuration

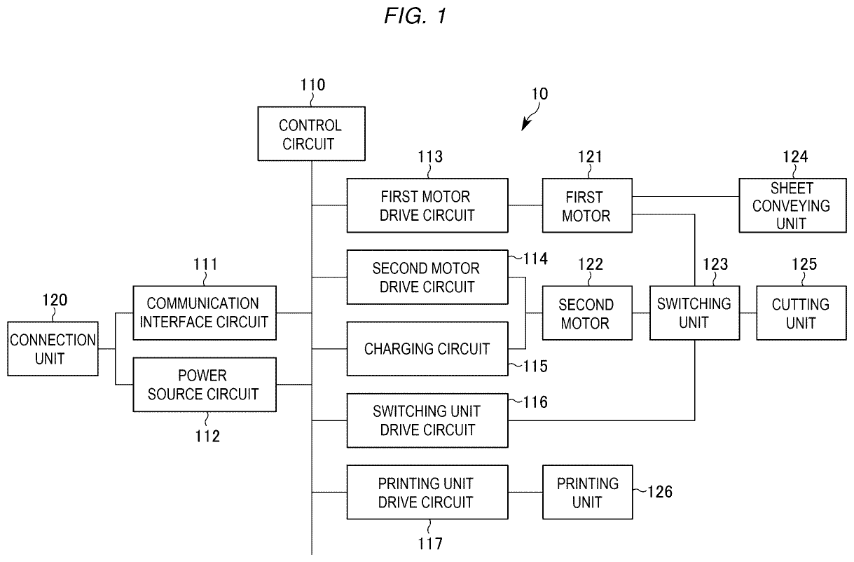

FIG. 1 is a block diagram illustrating a configuration example of a printer according to an embodiment. A printer 10 is a printer that performs printing on a printing sheet based on information input from the outside, cuts the printing sheet, and provides a printed material. The printer 10 is operated upon receiving electric power supplied via USB power delivery (USB PD) from an external power source device. The printer 10 includes a control circuit 110, a communication interface circuit 111, a power source circuit 112, a first motor drive circuit 113, a second motor drive circuit 114, a charging circuit 115, a switching unit drive circuit 116, a printing unit drive circuit 117, a connection unit 120, a first motor 121, a second motor 122, a switching unit 123, a sheet conveying unit 124, a cutting unit 125, and a printing unit 126.

The control circuit 110, the communication interface circuit 111, the power source circuit 112, the first motor drive circuit 113, the second motor drive circuit 114, the charging circuit 115, the switching unit drive circuit 116, and the printing unit drive circuit 117 are connected to one another by buses. The buses include a signal line for transmitting a control signal, a power source line for transmitting a power source voltage, and the like.

The control circuit 110 controls the operation of the entire printer 10. The control circuit 110 is, for example, a computer. The control circuit 110 includes, for example, a processor, a read only memory (ROM), a random access memory (RAM), and an auxiliary storage device. The processor corresponds to a central portion of the computer described above. The processor controls the units to implement various functions as the printer 10 according to an operating system or an application program. The processor is, for example, a central processing unit (CPU). The ROM is a non-volatile storage device. The ROM stores an operating system or an application program set in advance, control data, and the like. The RAM is a volatile storage device. The RAM is also used as a work area for rewriting data by the processor as appropriate. The RAM is also used as a buffer memory for temporarily storing data. The auxiliary storage device corresponds to an auxiliary storage portion of the computer. The auxiliary storage device stores data used by the processor to perform various kinds of processing, data created by processing in the processor, and the like. The auxiliary storage device may store the application program described above. The auxiliary storage device is, for example, an electric erasable programmable read only memory (EEPROM) (registered trademark), a hard disk drive (HDD), and a solid state drive (SSD).

The communication interface circuit 111 exchanges information with the outside of the printer 10. The communication interface circuit 111 is, for example, a universal serial bus (USB) (registered trademark) interface circuit.

The power source circuit 112 supplies power to each unit of the printer 10. The power source circuit 112 converts, for example, a voltage supplied from the outside of the printer 10 into a voltage used inside the printer 10. For example, the power source circuit 112 boosts a voltage of 20 V supplied via the USB PD to 24 V to be used inside the printer 10.

The first motor drive circuit 113 is a drive circuit that drives the first motor 121 to be described later. The first motor drive circuit 113 is, for example, a drive circuit of a stepping motor.

The second motor drive circuit 114 is a drive circuit that drives the second motor 122 to be described later. The second motor drive circuit 114 is, for example, a drive circuit of a DC motor.

The charging circuit 115 holds electric power generated by the second motor 122 to be described later, and supplies the held electric power to a power source line according to a state of a load of the printer 10. The charging circuit 115 includes, for example, a capacitor.

The switching unit drive circuit 116 is a drive circuit that drives the switching unit 123 to be described later. The switching unit drive circuit 116 is, for example, a drive circuit of a motor or a solenoid.

The printing unit drive circuit 117 is a drive circuit that drives the printing unit 126 to be described later. The printing unit drive circuit 117 is, for example, a drive circuit of a thermal head.

The connection unit 120 connects the outside of the printer 10 and the inside of the printer 10. The connection unit 120 is connected to the communication interface circuit 111 and the power source circuit 112. The connection unit 120 includes, for example, a USB Type-C connector. A USB cable is connected to the connection unit 120 from the outside, data communication is transmitted to the communication interface circuit 111, and power supply via the USB PD is transmitted to the power source circuit 112.

The first motor 121 is driven by the first motor drive circuit 113, and outputs a rotational force to the switching unit 123 and the sheet conveying unit 124, which will be described later. The first motor 121 is, for example, a stepping motor.

The second motor 122 is driven by the second motor drive circuit 114 and outputs a rotational force to the switching unit 123, which will be described later. The second motor 122 is rotated by the first motor 121 via the switching unit 123 to be described later, and outputs generated electric power to the charging circuit 115. The second motor 122 is, for example, a DC motor.

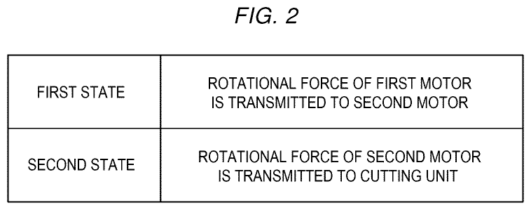

The switching unit 123 switches connection of the second motor 122. FIG. 2 is a table illustrating a state of the switching unit of the printer according to the embodiment. As illustrated in FIG. 2, the switching unit 123 switches between a first state in which the rotational force of the first motor 121 is transmitted to the second motor 122 and a second state in which the rotational force of the second motor 122 is transmitted to the cutting unit 125. The switching unit 123 includes, for example, a gear for transmitting a rotational force, and a motor or a solenoid for switching the gear.

Description will be made with reference to FIG. 1 again. The sheet conveying unit 124 receives the rotational force of the first motor 121 and conveys a printing sheet. The sheet conveying unit 124 is also called, for example, a platen roller.

The cutting unit 125 receives the rotational force of the second motor 122 and cuts the printing sheet. The cutting unit 125 includes a blade for cutting the printing sheet.

The printing unit 126 forms an image on the printing sheet. The printing unit 126 is, for example, a thermal head.

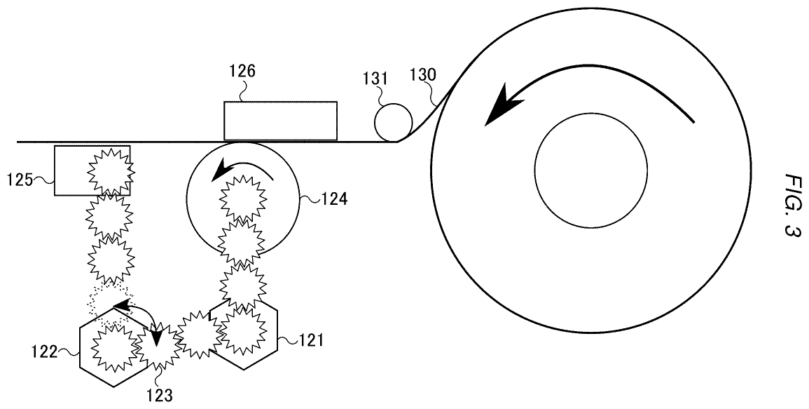

FIG. 3 is a schematic diagram illustrating an arrangement of the units in the printer according to the embodiment. The printer 10 further includes a guide roller 131. The guide roller 131 adjusts a traveling direction of the printing sheet. FIG. 3 illustrates the first motor 121, the second motor 122, the switching unit 123, the sheet conveying unit 124, the cutting unit 125, the printing unit 126, a printing sheet 130, and the guide roller 131.

The printing sheet 130 is wound in a roll shape and accommodated in the printer 10. The printing sheet 130 is, for example, thermal paper. The printing sheet 130 is drawn out from a rolled state, changes a direction along the guide roller 131, passes between the sheet conveying unit 124 and the printing unit 126, and is routed near the cutting unit 125.

The rotational force of the first motor 121 is transmitted to the sheet conveying unit 124 via a gear. When the sheet conveying unit 124 is rotated, the printing sheet 130 is conveyed from an upstream side wound in a roll shape to a downstream side where the cutting unit 125 is provided.

The sheet conveying unit 124 and the printing unit 126 sandwich the printing sheet 130. The printing unit 126 forms an image on the printing sheet 130 at a sandwiched portion. The printing unit 126 sequentially forms images corresponding to the rotation of the sheet conveying unit 124, thereby forming a desired image on the printing sheet 130.

A part of the switching unit 123 is provided between the first motor 121 and the second motor 122. In the example illustrated in FIG. 3, the switching unit 123 is in the first state, and a gear that is a part of the switching unit 123 transmits the rotational force of the first motor 121 to the second motor 122. When the switching unit 123 is in the second state, the gear of the switching unit 123 indicated by a solid line in FIG. 3 does not function, and the gear indicated by a broken line in FIG. 3 functions as a part of the switching unit 123 and transmits the rotational force of the second motor 122 to the cutting unit 125.

The cutting unit 125 is provided downstream of the sheet conveying unit 124 and the printing unit 126. When the rotational force of the second motor 122 is transmitted to the cutting unit 125 after the image formation on the printing sheet 130 by the printing unit 126 is completed, the cutting unit 125 cuts the printing sheet 130 by moving a built-in blade.

### Operations

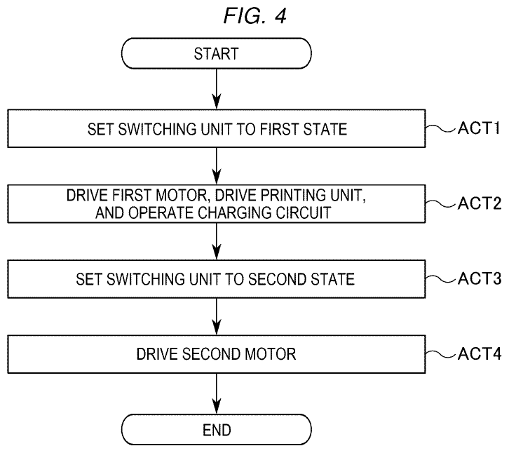

The operation of the printer 10 will be described. FIG. 4 is a flowchart illustrating a printing operation of the printer according to the embodiment. When the communication interface circuit 111 receives the print instruction, a series of processing illustrated in FIG. 4 is executed.

The printer 10 sets the switching unit 123 to the first state (ACT1). Specifically, the control circuit 110 controls the switching unit drive circuit 116 to set the switching unit 123 to the first state.

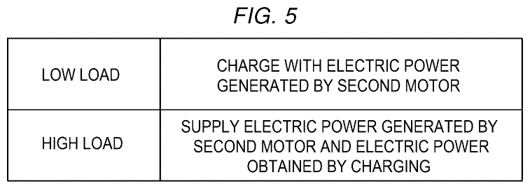

The printer 10 drives the first motor 121, drives the printing unit 126, and operates the charging circuit 115 (ACT2). Specifically, the control circuit 110 controls the first motor drive circuit 113 to drive the first motor 121, controls the printing unit drive circuit 117 to drive the printing unit 126, and controls and operates the charging circuit 115. When the first motor 121 is driven, the sheet conveying unit 124 that received the rotational force of the first motor 121 conveys the printing sheet 130. Further, the printing unit 126 driven by the printing unit drive circuit 117 forms an image on the printing sheet 130 conveyed by the sheet conveying unit 124. Since the switching unit 123 is in the first state, the rotational force of the first motor 121 is transmitted to the second motor 122, and the second motor 122 generates electric power. The electric power generated by the second motor 122 is handled by the charging circuit 115 in operation. Details of the operation of the charging circuit 115 will be described with reference to FIG. 5.

FIG. 5 is a table illustrating the operation of the charging circuit of the printer according to the embodiment. As illustrated in FIG. 5, the charging circuit 115 is charged with the electric power generated by the second motor 122 when a load of the printing unit 126 is low. On the other hand, when the load of the printing unit 126 is high, the charging circuit 115 supplies the electric power generated by the second motor and the electric power obtained by charging to a power source line. The low load or the high load of the printing unit 126 indicates whether the electric power consumed by the printing unit drive circuit 117 is small or large when the printing unit 126 forms an image. For example, when the image formed by the printing unit 126 is a character string, since the character string includes a blank portion, an amount of electric power consumed by the printing unit drive circuit 117 is not too large. That is, the load is low. On the other hand, for example, when the image formed by the printing unit 126 is a filled outline, since there is no blank portion in a printing line, an amount of electric power consumed by the printing unit drive circuit 117 is large. That is, the load is high. As described above, the magnitude of the electric power consumed by the printing unit drive circuit 117 changes according to contents of the image formed by the printing unit 126. The charging circuit 115 switches the operation according to the load of the printing unit 126.

Description will be made with reference to FIG. 4 again. When the processing of ACT2 is completed, the printer 10 sets the switching unit 123 to the second state (ACT3). Specifically, the control circuit 110 controls the switching unit drive circuit 116 to set the switching unit 123 to the second state.

The printer 10 drives the second motor 122 (ACT4). Specifically, the control circuit 110 controls the second motor drive circuit 114 to drive the second motor 122. Since the switching unit 123 is in the second state, the rotational force of the second motor 122 is transmitted to the cutting unit 125, and the cutting unit 125 cuts the printing sheet 130.

When the processing of ACT4 is completed, a series of processing illustrated in FIG. 4 is completed. When the series of processing illustrated in FIG. 4 is completed, the printer 10 outputs the cut printing sheet 130 on which an image is formed based on the print instruction received by the communication interface circuit 111.

### Effects

In image formation using a thermal head, power consumption changes depending on print contents. In particular, when printing is performed in the entire of a printing line such as a filled outline, power consumption is large. On the other hand, when a printing area is small, the power consumption is small. When a printed material is to be actually created, the power consumption during printing varies depending on print contents. For example, in a printed material such as a receipt having characters at the center, a large amount of electric power is instantaneously consumed in an outline portion, and power consumption is small in a character portion. When no particular measure is taken, an external power source device that supplies electric power to the printer is required to have a power supply capability capable of coping with maximum power consumption. However, a power source device capable of coping with large power consumption, specifically, a power source device having large rated power, a power source device coping with peak power, or the like may be large and expensive compared to a power source device having small rated power or a power source device that does not cope with peak power.

According to the embodiment, the printer 10 includes the second motor 122 that, when a rotational force is applied, converts the applied rotational force into electric power, and when electric power is applied, converts the applied electric power into a rotational force, and the charging circuit 115 that holds the electric power converted from the rotational force of the first motor 121 by the second motor 122 and supplies the held electric power when the printing unit 126 forms an image. Accordingly, the printer 10 according to the embodiment can reduce a maximum value of electric power required for the external power source device when the printing unit 126 forms an image. Therefore, even when electric power is supplied via USB PD that does not support peak power equal to or higher than rated power, it is possible to operate the printer 10 stably with power consumption within the rated power.

According to the embodiment, the printer 10 further includes the cutting unit 125 that cuts a sheet and the switching unit 123 that switches between the first state in which the rotational force of the first motor 121 is transmitted to the second motor 122 and the second state in which the rotational force of the second motor 122 is transmitted to the cutting unit 125. Accordingly, the printer 10 according to the embodiment can use the second motor 122 for both power generation and driving of the cutting unit, and costs can be reduced.

According to the embodiment, the switching unit 123 of the printer 10 maintains the first state during the printing unit 126 forms an image. Accordingly, the printer 10 can operate the second motor 122 to generate electric power and operate the charging circuit 115 at a timing when power consumption increases, and can reduce a maximum value of the electric power required for the external power source device.

According to the embodiment, the first motor 121 is a stepping motor, and the second motor 122 is a DC motor. Accordingly, the first motor 121 can accurately convey the printing sheet 130 in accordance with the formation of an image by the printing unit 126. The second motor 122 can perform driving and power generation with a simpler circuit than a stepping motor or the like.

### Other Modifications

Although a case where the print instruction is transmitted to the communication interface circuit 111 via the connection unit 120, that is, a case where the print instruction is input via the USB cable has been described as an example in the embodiment described above, the print instruction may be input via another path. For example, the printer 10 may further include another communication interface such as wireless communication, and may receive the print instruction via the another communication interface.

While certain embodiments have been described, these embodiments have been presented by way of examples only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A printer, comprising:
a first motor configured to feed a printing sheet;
a printing component configured to form an image on the printing sheet;
a second motor configured to, when a first rotational force of the first motor is applied to the second motor, convert the applied rotational force into electric power, and when electric power of a power source circuit is applied to the second motor, convert the electric power of the power source circuit into a second rotational force;
a charging circuit configured to hold the electric power converted by the second motor from the first rotational force of the first motor and supply the held electric power when the printing component forms the image; and
a connection component configured to receive electric power supplied via USB power delivery.

2. The printer according to claim 1, further comprising:
a cutting component configured to cut the printing sheet; and
a switching component configured to switch between a first state in which the first rotational force of the first motor is transmitted to the second motor and a second state in which the second rotational force of the second motor is transmitted to the cutting component.

3. The printer according to claim 2, wherein
the switching component maintains the first state while the printing component is forming an image.

4. The printer according to claim 1, wherein
the first motor is a stepping motor, and the second motor is a DC motor.

5. The printer according to claim 1, wherein
the printing component includes a thermal head.

6. The printer according to claim 2, wherein
the switching component comprises a gear for transmitting the first rotational force, and one of a third motor or a solenoid for switching a gear.

7. The printer according to claim 6, further comprising:
a control circuit that controls the switching component between the first state and the second state.

8. A method for a printer, comprising:
feeding a printing sheet by a first motor;
forming an image on the printing sheet;
when a first rotational force of the first motor is applied to a second motor, converting the applied rotational force into electric power;
when electric power of a power source circuit is applied to the second motor, converting the electric power of the power source circuit into a second rotational force;
holding the electric power converted by the second motor from the first rotational force of the first motor in a charging circuit;
supplying the held electric power when forming the image; and
receiving electric power supplied through a connection component via USB power delivery.

9. The method according to claim 1, further comprising:
cutting the printing sheet with a cutting component; and
switching between a first state in which the first rotational force of the first motor is transmitted to the second motor and a second state in which the second rotational force of the second motor is transmitted to the cutting component.

10. The method according to claim 9, further comprising:
maintaining the first state while the printing component is forming an image.

11. The method according to claim 8, wherein
the first motor is a stepping motor, and the second motor is a DC motor.

12. The method according to claim 9, further comprising:
transmitting the first rotational force by a gear of a switching component; and
switching the gear using one of a third motor or a solenoid.

13. The method according to claim 12, further comprising:
controlling the switching component between the first state and the second state.

14. A thermal printer, comprising:
a first motor configured to feed a printing roll sheet;
a guide roller configured to adjust a traveling direction of the printing roll sheet;
a thermal printing component configured to form an image on the printing roll sheet;
a second motor configured to, when a first rotational force of the first motor is applied to the second motor, convert the applied rotational force into electric power, and when electric power of a power source circuit is applied to the second motor, convert the electric power of the power source circuit into a second rotational force;
a charging circuit configured to hold the electric power converted by the second motor from the first rotational force of the first motor and supply the held electric power when the thermal printing component forms the image; and
a connection component configured to receive electric power supplied via USB power delivery.

15. The thermal printer according to claim 14, further comprising:
a cutting component configured to cut the printing roll sheet; and
a switching component configured to switch between a first state in which the first rotational force of the first motor is transmitted to the second motor and a second state in which the second rotational force of the second motor is transmitted to the cutting component.

16. The thermal printer according to claim 15, wherein
the switching component maintains the first state while the thermal printing component is forming an image.

17. The thermal printer according to claim 14, wherein
the first motor is a stepping motor, and the second motor is a DC motor.

18. The thermal printer according to claim 14, wherein
the thermal printing component includes a thermal head.

19. The thermal printer according to claim 15, wherein
the switching component comprises a gear for transmitting the first rotational force, and one of a third motor or a solenoid for switching a gear.

20. The thermal printer according to claim 19, further comprising:
a control circuit that controls the switching component between the first state and the second state.
